(19) United States
(12) Patent Application Publication
(10) Pub. No.: US 2022/0266514 A1
(43) Pub. Date: Aug. 25, 2022

(54) ADDITIVE MANUFACTURING APPARATUS WITH PURGED LIGHT ENGINE

(71) Applicant: Carbon, Inc., Redwood City, CA (US)

(72) Inventors: Anant Chimmalgi, Los Altos, CA (US); Ariel M. Herrmann, San Francisco, CA (US); Jordan Christopher Fidler, Millbrae, CA (US); Sean Patrick Wheeler, San Jose, CA (US); Alexander Portnoy, Los Gatos, CA (US); Fabian Cheah, San Mateo, CA (US); Xinyu Gu, San Mateo, CA (US); Angelo Menotti, Union City, CA (US)

(21) Appl. No.: 17/630,760

(22) PCT Filed: Jul. 24, 2020
(86) PCT No.: PCT/US2020/043484

§ 371 Date: Jan. 27, 2022

Related U.S. Application Data
(60) Provisional application No. 62/883,425, filed on Aug. 6, 2019.

(51) Int. Cl. B29C 64/277; B29C 64/371

(52) U.S. Cl. CPC B29C 64/277; B29C 64/371; B33Y 30/00

(57) ABSTRACT

An additive manufacturing apparatus (10) includes (a) a light polymerizable resin unit comprising a surface on which a light polymerizable resin can be supported; (b) a light engine (17) configured to illuminate a region of the light polymerizable resin unit; (c) a carrier platform on which an object can be produced; (d) a drive assembly operatively associated with the carrier platform for advancing said carrier platform (12) and said light polymerizable resin unit away from one another as said object is produced; (e) a purge chamber (300) surrounding at least a portion of said light engine (17); and (f) a purge gas in said purge chamber, or a purge gas supply operatively associated with said purge chamber (300).

### RELATED APPLICATION

This application claims priority to U.S. Provisional Application Ser. No. 62/883,425, filed Aug. 8, 2019, the disclosure of which is hereby incorporated by reference in its entirety.

### FIELD OF THE INVENTION

The present invention concerns additive manufacturing apparatus in which light engine fouling is reduced.

### BACKGROUND

A group of additive manufacturing techniques sometimes referred to as “stereolithography” creates a three-dimensional object by the sequential polymerization of a light polymerizable resin. Such techniques may be “bottom-up” techniques, where light is projected into the resin on the bottom of the growing object through a light transmissive window, or “top down” techniques, where light is projected onto the resin on top of the growing object, which is then immersed downward into the pool of resin.

The recent introduction of a more rapid stereolithography technique known as continuous liquid interface production (CLIP), coupled with the introduction of “dual cure” resins for additive manufacturing, has expanded the usefulness of stereolithography from prototyping to manufacturing (see, e.g., U.S. Pat. Nos. 9,211,678; 9,205,601; and 9,216,546 to DeSimone et al.; and also in J. Tumbleston, D. Shirvanyants, N. Ermoshkin et al., Continuous liquid interface production of 3D Objects, Science 347, 1349-1352 (2015); see also Rolland et al., U.S. Pat. Nos. 9,676,963, 9,453,142 and 9,598,606).

### SUMMARY

The introduction of the family of additive manufacturing methods sometimes referred to as CLIP has allowed the apparatus to produce parts at greater speed. We have unexpectedly found, however, that the light engines of such apparatus can be prone to fouling. Without wishing to be bound to any particular theory of the invention, it is currently believed that greater speed of such apparatus leads to more significant heating of the resin during production, due to the exothermic nature of the light polymerization reaction. This heating apparently leads to excessive volatilization of resin constituents that foul components of the light engine situated beneath the light transmissive window, particularly prisms associated with the digital micromirror device (DMD) of such light engines. It further appears that common optical coatings on prisms can make such fouling worse. Accordingly, there is a need for new structures to additive manufacturing machines.

Hence, we find that that an additive manufacturing apparatus in which the light engine, or at least the DMD prism of the light engine, is purged with a clean or inert gas, improves the performance and reduces periodic maintenance requirements for that apparatus.

Purging may be carried out by enclosing the DMD and prism in a chamber (or the entire light engine). The chamber may be sealed with an atmosphere of an inert gas such as nitrogen or argon). Alternatively, the chamber may be provided with a flow of clean dry gas, such as clean dry air. In one embodiment, the flow of clean dry gas may have as a gas source the same gas source utilized to power pneumatically actuated components in the apparatus.

In some embodiments, an additive manufacturing apparatus includes (a) a light polymerizable resin unit comprising a surface on which a light polymerizable resin can be supported; (b) a light engine configured to illuminate a region of the light polymerizable resin unit; (c) a carrier platform on which an object can be produced; (d) a drive assembly operatively associated with the carrier platform for advancing said carrier platform and said light polymerizable resin unit away from one another as said object is produced; (e) a purge chamber surrounding at least a portion of said light engine; and (f) a purge gas in said purge chamber, or a purge gas supply operatively associated with said purge chamber.

In some embodiments, said light engine comprises optical components configured to direct light from the light engine to the light polymerizable resin unit, said purge chamber surrounding at least some of said optical components. In some embodiments, the optical components comprise a prism, and said purge chamber surrounds said prism. The optical components further comprise one or more micromirrors configured to direct light, and the purge chamber surrounds the one or more micromirrors. The purge chamber comprises a sealed chamber having an atmosphere of an inert gas (e.g., nitrogen or argon).

In some embodiments, the purge chamber is operatively associated with the purge gas supply. The purge gas supply may be a clean dry gas (e.g., clean dry air). In some embodiments, the gas supply comprises a gas source and one or more filters configured to purify a gas from the gas source.

In some embodiments, the additive manufacturing apparatus includes pneumatically actuated components, and the gas source is further configured to power said pneumatically actuated components in said additive manufacturing apparatus. The drive assembly comprises the pneumatically actuated components. In some embodiments, a manifold is configured to direct a gas flow from said gas source to said pneumatically actuated components or said purge gas chamber or both said pneumatically actuated components and said purge gas chamber.

In some embodiments, the light polymerizable resin unit surface comprises a light transmissive window, the light engine being positioned below the light transmissive window, and the carrier platform being positioned above said light transmissive window.

Embodiments according to the present invention may include “bottom up” or “top down” stereolithography techniques.

The foregoing and other objects and aspects of the present invention are explained in greater detail in the drawings herein and the specification set forth below. The disclosures of all United States patent references cited herein are to be incorporated herein by reference.

### DESCRIPTION OF THE DRAWINGS

FIG. 1 is a block diagram of an additive manufacturing apparatus according to some embodiments;

FIG. 2 is a schematic diagram of a light engine architecture according to some embodiments; and

FIG. 3 is a schematic diagram of a purge system architecture according to some embodiments.

### DETAILED DESCRIPTION

The present invention is now described more fully hereinafter with reference to the accompanying drawings, in which embodiments of the invention are shown. This invention may, however, be embodied in many different forms and should not be construed as limited to the embodiments set forth herein; rather these embodiments are provided so that this disclosure will be thorough and complete and will fully convey the scope of the invention to those skilled in the art.

As used herein, the term “and/or” includes any and all possible combinations of one or more of the associated listed items, as well as the lack of combinations when interpreted in the alternative (“or”).

High speed additive manufacturing apparatus are known and include those that implement the family of methods sometimes referred to as as continuous liquid interface production (CLIP). CLIP is known and described in, for example, U.S. Pat. Nos. 9,211,678; 9,205,601; 9,216,546; and others; in J. Tumbleston et al., Continuous liquid interface production of 3D Objects, Science 347, 1349-1352 (2015); and in R. Janusziewcz et al., Layerless fabrication with continuous liquid interface production, Proc. Natl. Acad. Sci. USA 113, 11703-11708 (Oct. 18, 2016). Other examples of methods and apparatus for carrying out particular embodiments of CLIP include, but are not limited to: Batchelder et al., US Patent Application Pub. No. US 2017/0129169 (May 11, 2017); Sun and Lichkus, US Patent Application Pub. No. US 2016/0288376 (Oct. 6, 2016); Willis et al., US Patent Application Pub. No. US 2015/0360419 (Dec. 17, 2015); Lin et al., US Patent Application Pub. No. US 2015/0331402 (Nov. 19, 2015); D. Castanon, US Patent Application Pub. No. US 2017/0129167 (May 11, 2017). B. Feller, US Pat App. Pub. No. US 2018/0243976 (published Aug. 30, 2018); M. Panzer and J. Tumbleston, US Pat App Pub. No. US 2018/0126630 (published May 10, 2018); and K. Willis and B. Adzima, US Pat App Pub. No. US 2018/0290374 (Oct. 11, 2018).

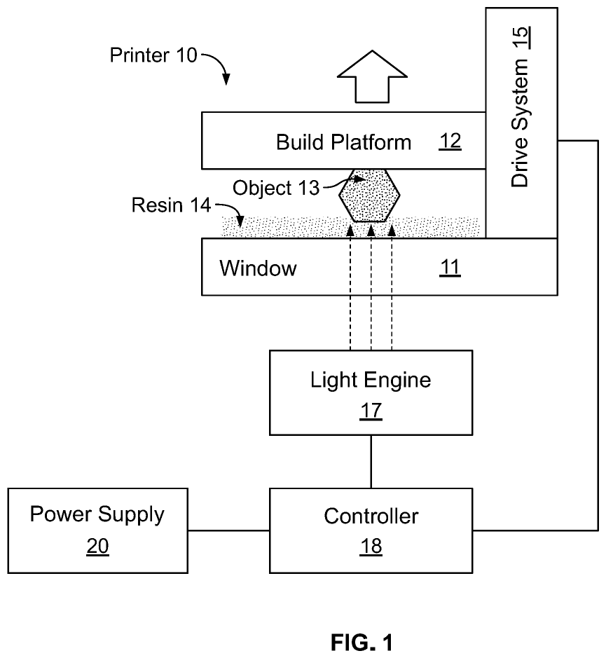

As illustrated in FIG. 1, an additive manufacturing apparatus or 3d printer 10 includes a light transmissive window 11 on which a light polymerizable resin 14 can be supported. A light engine 17 is positioned below the light transmissive window 11. A carrier or build platform 12 is positioned above the light transmissive window, and an object 13 can be produced thereon. A controller 18 powered by a power supply 20 is operatively associated with a drive assembly 15 and the light engine 17 to control the area illuminated by the light engine 17 and the drive system 15 to produce the object 13.

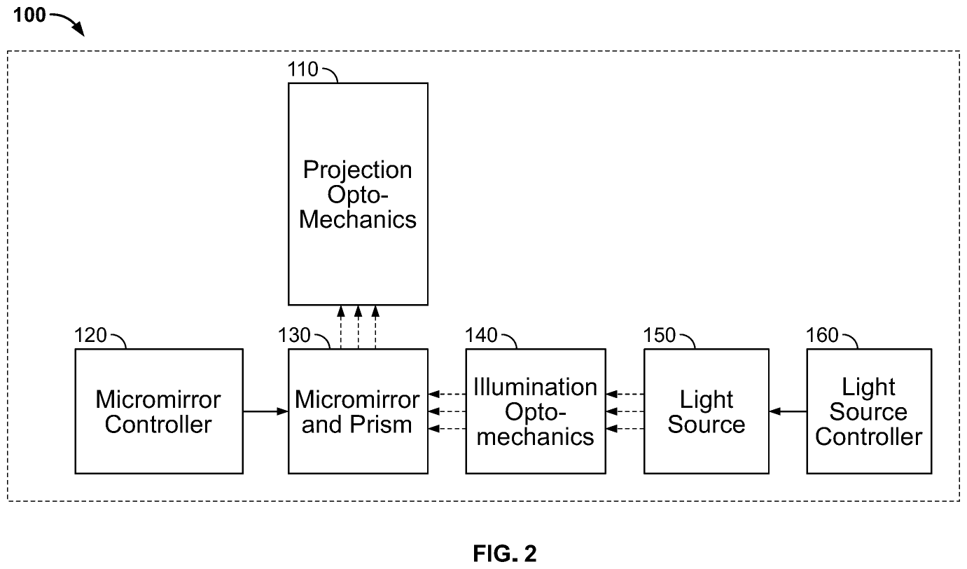

As shown in FIG. 2, a light engine architecture 100 for the light engine 17 includes various optical components and controllers, including projection opto-mechanics 110, a micromirror controller 120, a micromirror/prism 130 (e.g., a digital micromirror device (DMD)), illumination opto-mechanics 140, a light source 150 and a light source controller 160. The light source controller 160 controls light from the light source 150, which is then directed by the illumination opto-mechanics 140 and microromirro/prism 130, which are controller by the micromirror controller 120 such that light is directed from the micromirror/prism 130 to the projection opto-mechanics and projected onto the resin 14 (FIG. 1).

In some embodiments, a purge chamber surrounds at least a portion of the light engine. For example, the purge chamber may surround the micromirror and/or prism 130. The purge chamber may be a sealed chamber having an atmosphere of an inert gas such as nitrogen or argon or the purge chamber may be operatively associated with a purge gas supply. The purge gas supply may be a clean dry gas, such as clean dry air. The gas supply may be a gas source and one or more filters configured to purify the gas from the as source. For example, micro mist separators from SMC Pneumatics (AFD20-40, AFD Mist Separator, AMH850-20D micro mist separator), may be used.

In particular embodiments, the additive manufacturing apparatus may include pneumatically actuated components, such as drive assembly components, and the gas source may be used to power the pneumatically actuated components in the additive manufacturing apparatus in addition to being used to provide a purge gas to the optical components.

Embodiments according to the present invention may include “bottom up” or “top down” stereolithography techniques.

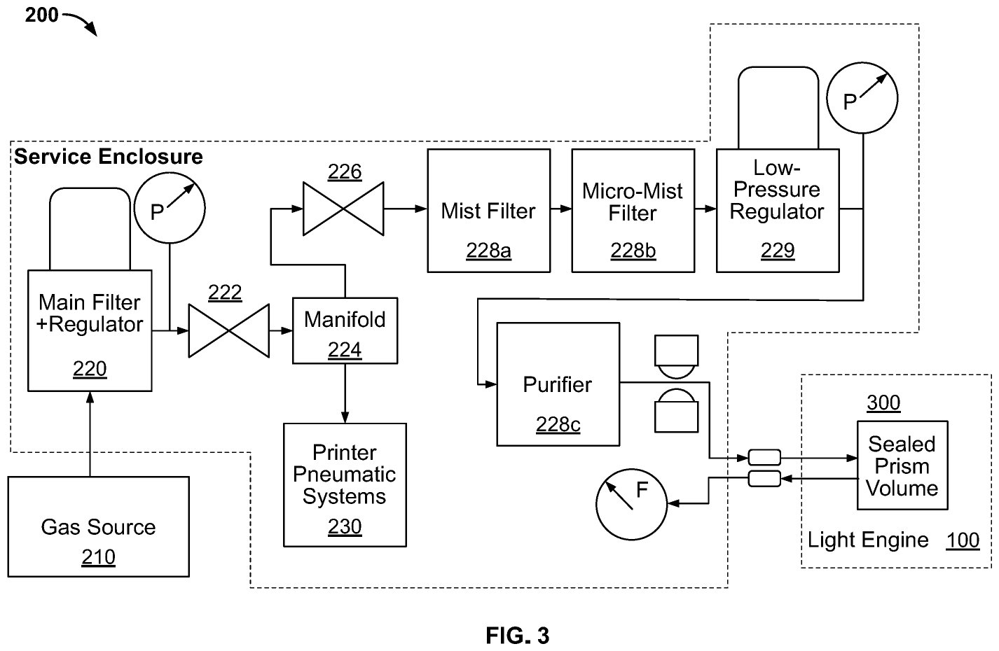

As shown in FIG. 3, the light engine 100 may include a purge chamber or sealed prism volume 300. The purge system architecture 200 includes a gas source 210 (e.g., facility CDA) that flows to a main filter/regulator 220 and a minfold 224 via a valve 222. The manifold 224 may direct gas to the printer or additive manufacturing apparatus pneumatic systems 230 and to filters 228a-228c and low pressure regulator 229 via a valve 226. The purified gas may be delivered to the sealed prism volume 300 of the light engine 100. As shown, the filters 228a-228c remove successively smaller particles (0.3 μm, 0.01 μm, and 0.003 μm, respectively). However, any suitable clean or inert gas may be used.

In some embodiments, an additive manufacturing apparatus in which the light engine, or at least the prism or DMD prism of the light engine, is purged with a clean or inert gas, improves the performance and reduces periodic maintenance requirements for that apparatus.

The foregoing is illustrative of the present invention, and is not to be construed as limiting thereof. The invention is defined by the following claims, with equivalents of the claims to be included therein.

1. An additive manufacturing apparatus, comprising:
(a) a light polymerizable resin unit comprising a surface on which a light polymerizable resin can be supported;
(b) a light engine configured to illuminate a region of the light polymerizable resin unit;
(c) a carrier platform on which an object can be produced;
(d) a drive assembly operatively associated with the carrier platform for advancing said carrier platform and said light polymerizable resin unit away from one another as said object is produced;
(e) a purge chamber surrounding at least a portion of said light engine; and
(f) a purge gas in said purge chamber, or a purge gas supply operatively associated with said purge chamber.

2. The additive manufacturing apparatus of claim 1, wherein said light engine comprises optical components configured to direct light from the light engine to the light polymerizable resin unit, said purge chamber surrounding at least some of said optical components.

3. The additive manufacturing apparatus of claim 2, wherein said optical components comprise a prism, and said purge chamber surrounds said prism.

4. The additive manufacturing apparatus of claim 3, wherein said optical components further comprise one or more micromirrors configured to direct light, and said purge chamber surrounds said one or more micromirrors.

5. The additive manufacturing apparatus of claim 4,
wherein said purge chamber comprises a sealed chamber having an atmosphere of an inert gas.

6. The additive manufacturing apparatus of claim 4, wherein said purge chamber is operatively associated with said purge gas supply.

7. The additive manufacturing apparatus of claim 6, wherein said purge gas supply comprises a clean dry gas.

8. The additive manufacturing apparatus of claim 7, wherein said gas supply comprises a gas source and one or more filters configured to purify a gas from the gas source.

9. The additive manufacturing apparatus of claim 8, further comprising pneumatically actuated components, wherein said gas source is further configured to power said pneumatically actuated components in said additive manufacturing apparatus.

10. The additive manufacturing apparatus of claim 9, wherein said drive assembly comprises said pneumatically actuated components.

11. The additive manufacturing apparatus, claim 9 further comprising a manifold configured to direct a gas flow from said gas source to said pneumatically actuated components or said purge gas chamber or both said pneumatically actuated components and said purge gas chamber.

12. The additive manufacturing apparatus of claim 1, wherein said light polymerizable resin unit surface comprises a light transmissive window, said light engine being positioned below said light transmissive window, and said carrier platform being positioned above said light transmissive window.
